(19) United States
(12) Patent Application Publication
(10) Pub. No.: US 2007/0232308 A1
(43) Pub. Date: Oct. 4, 2007

(54) Method for Multimedia Broadcast Multicast Service Linking for Pmm Idle Mobiles

(76) Inventors: Joachim Karl Olof Bergstrom, Stockholm (SE); Jacques Sagne, Stockholm (FR); Peter Edlund, Tumba (SE)

Correspondence Address: ERICSSON INC., 6300 LEGACY DRIVE, M/S EVR 1-C-11, PLANO, TX, 75024, US

(21) Appl. No.: 10/596,883

(22) PCT Filed: Mar. 18, 2004
(86) PCT No.: PCT/SE04/00402

§ 371 Date: Jun. 28, 2006

(30) Foreign Application Priority Data
Jan. 9, 2004 (SE) 0400055-0

(51) Int. Cl. H04Q 7/20

(52) U.S. Cl. 455/436

(57) ABSTRACT

A method and arrangement in a mobile telecommunication system for initiating a Multimedia Broadcast Multimedia Service (MBMS) to a User Equipment (UE) in Packet Mobility Management-idle (PMM-idle) mode controlled by a Radio Network Controller (RNC). The RNC is connected to a Serving GPRS Support Node (SGSN). The RNC indicates to the SGSN that the UE is transiting to a Circuit Switched connected mode. The RNC receives an MBMS UE context from the SGSN. The MBMS UE context is added to the RNC to make it aware that the RNC controls UEs connected to the MBMS.

### FIELD OF THE INVENTION

The present invention relates to a mobile telecommunication system.

In particular, the present invention relates to methods and arrangements for handling the Multimedia Broadcast Multicast Service (MBMS) in a third generation mobile telecommunication system.

### BACKGROUND OF THE INVENTION

The work item Multimedia Broadcast Multicast Service (MBMS) is currently being standardised for release 6 within the Third Generation Partnership Project (3GPP). There are two modes of operation defined, the broadcast and the multicast mode. The present invention relates to the multicast mode.

MBMS may e.g. be used to provide streaming or download services in a point to multi-point manner. I.e. instead of that each user listens/downloads a service on an individual basis, a large number of users utilize the same transmission. In this way it is possible to substantially decrease the radio resource utilisation in the case when the number of users sharing the same service is large. Taking this into account, MBMS is likely to be used for e.g. video clips from sport events, weather or traffic information, etc.

The transmission of MBMS Data is initiated in the radio access network (RAN) with a Session Start message sent from the Serving GPRS Support Node (SGSN), in the Core Network (CN), to all the Radio Network Controllers (RNCs) serving mobile terminals that have joined the MBMS. An RNC is considered to have joined MBMS mobile terminals if it e.g. covers a Routing Area (RA) where there are PMM-IDLE User Equipments (UEs), also referred to as mobile terminals, that have joined the MBMS. Another example is when the RNC is acting as Serving RNC (S-RNC) or Drift RNC (D-DRC) for a UE that have joined the MBMS service.

(The S-RNC is a RNC that has a Radio Resource Connection (RRC) connection with the UE while the D-RNC is a RNC that may be connected to the UE on the radio interface via one of its cells, but where another RNC, i.e. the S-RNC, handles the RRC connection with the UE. When the UE is in PMM-CONNECTED state the UE has a signalling connection to the Packet Switched (PS) domain. The UE is then able to perform signalling towards the PS domain in the core network (CN) with a direct transfer message that goes directly to the corresponding SGSN. When the UE is in PMM-IDLE state, the UE has no signalling connection to the packet switched (PS) domain. The UE only performs Routing area updates when it changes RA to inform the SGSN that it has moved.)

Further, each PMM-CONNECTED UE that has joined a certain MBMS service is linked to the MBMS Service context in the serving RNC by dedicated signalling, which takes place between an RNC and the CN. It should be noted that the MBMS service context is already negotiated between the UE and the SGSN before the linking between the UE and the RAN is performed. The negotiation may be performed during a registration procedure. The MBMS services that is applicable to the UE is communicated to the RNC. If there is no previous context for this particular MBMS service the MBMS Service Context is created in the RNC.

Linking over Iu is performed for a UE in PMM-CONNECTED mode when the UE joins the MBMS service or for a UE that earlier has joined the MBMS service that sets up a PS-Radio Access Bearer. This implies that for a mobile in RRC Connected and PMM Connected there is a S-RNC that has stored MBMS UE Context for said UE.

Furthermore, the SGSN is responsible to inform the S-RNC of each UE that is PMM-CONNECTED and that has joined a certain MBMS service through the UE linking procedure. I.e. the SGSN sends the IMSI of the concerned UEs together with a list of MBMS services the UE has joined to the S-RNC.

In the existing systems, only PMM-CONNECTED UEs are known in the S-RNC and are thus able to receive a message corresponding to the message Session start on the Uu-interface, i.e. the radio interface. PMM_Idle UEs are not known in RAN, but are capable to receive Session Start on the Uu-interface if they are paged in the RA by the SGSN. All UEs need to know when the MBMS session is starting in order to be able to tune/listen to the right channel where the service is going to be transmitted. The session start message is sent from the Core Network (CN), i.e. the SGSN, to the RNC, then all UEs are notified by the RNC based on which state they are in.

The UEs in PMM-CONNECTED state get UE specific handling such as MBMS specific paging or MBMS notification. UEs in RRC idle mode listen to specific common MBMS control channels in order to monitor when the MBMS service starts on the MBMS Control Channel (MCCH). In the case when a UE that is PMM-IDLE and Circuit Switched (CS) Connected, that e.g. has an ongoing speech/video/data call, the S-RNC has no knowledge about that the UE has joined the MBMS service and the UE will therefore not be paged individually.

However, the S-RNC in its role of Controlling RNC (C-RNC) may in some cases page for idle UEs. This happens when there are Idle UEs that have joined the MBMS in the RA to which the S-RNC is part of. In this case, the PMM-Idle UEs will be paged by the C-RNC in a broadcast manner. However, a UE (depending on the UE capability) involved in a dedicated communication (e.g. a speech call) will typically not listen to any specific common MBMS control channels carrying the indication that the MBMS service is starting. This implies that the UEs that are PMM-Idle and RRC Connected may not be able to receive the indication of a session start. Also in RRC connected mode, the UE relies on that the RNC indicates various service starts (i.e. not only MBMS, but also other incoming speech calls, etc.) to the UE. Further, some UEs are not even capable of being PMM-CONNECTED and having a speech call at the same time.

As described above, this is only valid when the UE is in the states PMM-IDLE and CS connected because when the UE is only PMM-IDLE and not CS-CONNECTED or PS-CONNECTED, the UE is RRC idle. The UE in RRC idle state listens to the specific common MBMS Control Channel (MCCH). So in that case, there is no risk that the UE will miss the start of the MBMS service.

In order to further illustrate the above described problem, the following scenario is described. The normal scenario is that a UE is RRC idle and is listening to broadcast information, i.e. the UE is not involved in a speech call, or is actively performing web surfing downloads etc. This means that when the MBMS service is starting by transmitting the session start message to the RNC from the SGSN the RRC idle UEs listen to the common MBMS control message sent on a common control channel in a broadcast manner on the MCCH and the UEs are hence aware of that the MBMS session is started. For the UEs that are actively involved in a call, the RNC knows by means of the UE linking for PMM_CONNECTED UEs, that these UEs also require an MBMS session start indication. If they listen to a channel that does not allow them to receive the common MBMS control channel messages the RNC will send the session start indication on a per UE basis (i.e. in dedicated mode).

However, for UEs that are involved in a CS call (e.g. a speech conversation) situations may occur when they are not PMM-CONNECTED, even though they would like to receive an MBMS session, and for those UEs the RNC is not aware of that it may be required to send a session start indication per UE.

Existing solutions to the above described problem are discussed in the following:

In a first existing solution, the UE sends a MBMS JOINED SERVICE INDICATION message to the S-RNC when the UE transits to RRC Connected while in PMM-IDLE. This message contains a list of the MBMS services that the UE has joined and is stored in the RNC as long as the UE is RRC Connected, i.e. CS connected, and PMM-IDLE (e.g. doing a speech call). For this first existing solution, it is provided that a session start indication is available from the CN for that RNC while the solutions described below do not require such a session start indication. The session start indication is transmitted from the CN to the responsible SGSN. The SGSN distributes session start indications over one or several Iu connections depending on the MBMS Service Context. Registrations/routing area updates are sent at session start and the may also be sent depending on the chosen architecture during the session from the core network, but the assumption in the present invention, is that the RAN should be responsible for scheduling the session start periodically during the session in order to make new MBMS Ues aware of the session. For idle UEs performing RA updates during the session, it is the responsibility of the SGSN to provide the RAN with information on new RA's. The session starts includes e.g. information on Session Id or IMSI or other information necessary for updating the MBMS service context. The solution is further described in the specification 3GPP TS 25.346 v2.4.0, Introduction of Multimedia Broadcast Multicast Service (MBMS) in the Radio Access Network (Stage 2), Release 6.

A second existing solution is that all UEs that have joined an MBMS service are required to enter PMM-CONNECTED if they transit to RRC Connected for any reason. By requiring this a UE that e.g. is performing a speech call will be in PMM-CONNECTED and is linked in a normal fashion and the S-RNC will therefore be aware of that the UE has joined an MBMS service. That the UE is linked implies that a UE linking has been performed for these UEs between the SGSN and the RNC.

Still another solution, a third solution, is to include all the identities of the UEs that have joined that MBMS service and that are in PMM-IDLE and in a Routing Area (RA), comprising cells belonging to that RNC, when the SGSN sends the session start message to an RNC. The RNC is then able to check these UE identities against all the identities for which the RNC have an active RRC context identifying all the RRC connected and PMM-IDLE UEs. The RNC then sends a dedicated indication to all the UEs that are PMM-IDLE and RRC connected that the MBMS transmission starts.

A fourth solution is similar to the third solution in the way that when the SGSN sends the session start indication to an RNC it also includes all the identities of the UEs that have joined that MBMS service and that are in PMM-IDLE and in a RA with cells belonging to that RNC. The RNC is then able to check these UE identities against all the identities for which the RNC have an active RRC context identifying all the RRC connected and PMM-IDLE UEs. However, instead (compared to the third solution) the RNC then sends a MBMS PMM-CONNECTED STATE REQUIRED IND message forcing the UEs to transit to PMM-CONNECTED, which initiates the SGSN to initiate the UE linking that is previously described. This will also result in that the UEs receives an indication about that the MBMS transmission is starting in a similar manner as for the UEs that were PMM-CONNECTED from the beginning.

A disadvantage with the first solution is that the RNC requires a start indication from the CN. In the first solution, the SGSN is not aware of that the UE has joined the MBMS, since no signalling is performed from the RNC to the SGSN, but when other UEs have joined the MBMS, the SGSN will then send the start indication which triggers paging of MBMS UEs. However, there are cases when the RNC does not receive the start indication from the CN. One such situation may be if there are no other UEs under this RNC that are PMM-CONNECTED (i.e the UEs have not been linked) or have done a Routing Area update in a RA in this RNC and therefore, there is no reason for the SGSN to send the start indication to the RNC even though the RNC have an indication directly from the UE that the UE wants to receive an MBMS service. Another disadvantage is that new RRC messages or Uu procedures are required. New Uu procedures implies more signalling on the radio interface and therefore unnecessary use of radio resources. It should be noted that the other solutions comprise means for transmitting information to the SGSN to send a start indicaton. Thus, all solutions comprise means for transmitting the message Session Start from the SGSN.

A disadvantage with the second solution is that an increased number of PMM-Connected states have to be handled by the SGSN. Each CS-Connection that is set up also requires context handling in the PS domain. That results in additional load in the CN.

A further disadvantage with the second solution is that additional authentication/security procedures need to be processed in the SGSN

A disadvantage with the third solution is that it may result in some potential delay, since the process is started when session start is received it might take some time before all the signalling is completed.

Another disadvantage is that the third solution requires the UEs to transit to PMM-CONNECTED all the time, and this means additional signalling, i.e. increased load on the radio interface and on the interface between the SGSN and the RNC. The solution also has the disadvantage that transition into PMM-CONNECTED mode sometimes requires an authentication of the UE resulting in even more Iu and Uu signalling.

Moreover, it is a disadvantage with the third and fourth existing solutions that there will be a high processing load in the RNC performing a cross checking of the list with the identities of the UEs in the session start message versus the list of the identities of the UEs already stored in the RNC with active RRC connections. The load in the SGSN may be momentarily high since there is a need for all UEs to perform the linking at the same time instead of spreading this procedure over time. In addition, the peak load collides with the time instant when the service is started and the RNC potentially also need to perform counting of MBMS UEs. All these procedures potentially include Uu signaling that may result in radio interface congestion. A further disadvantage is that the fourth solution is complex and requires both Uu and MM procedures.

### SUMMARY OF THE INVENTION

As mentioned above, it is a problem to initiate an MBMS service when a UE is PMM-IDLE and at the same time is Circuit Switched (CS) Connected, since the S-RNC has no knowledge whether the UE has joined the MBMS service. Thus, the UE will not listen to a broadcast of potential indications to start the MBMS transmission.

It is thus an object with the present invention to provide methods and arrangements for solving the above described problem without the above mentioned drawbacks.

The problem is solved by the methods of claims 1,2 and 10 and arrangements of claims 8, 9, 15-18 and 24.

Embodiments of the present invention are defined by the dependent claims.

An advantage with the present invention is that there is no duplication of MBMS linking procedures. No extra linking on the radio interface between the UE and the RNC is required. Thus, only the linking on the Iu interface between the SGSN and RNC is required.

A further advantage is that the load in the RNC and in the SGSN related to creating contexts, performing linking and processing of UE identities, for UEs that are RRC Connected and PMM-IDLE, are spread over time. Thus, the load on the radio interface is spread over time which reduces the risk for congestions.

A further advantage with the present invention is that the processing in the nodes is reduced.

### BRIEF DESCRIPTION OF THE DRAWINGS

FIG. 1 illustrates a third generation mobile telecommunication system wherein the present invention may be implemented.

FIG. 2 illustrates schematically a procedure according to a first embodiment of the present invention.

FIG. 3 illustrates schematically a procedure according to a second embodiment of the present invention.

FIG. 4 shows a flowchart of the method according to a first embodiment of the present invention.

FIG. 5 shows a flowchart of the method according to a second embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather these embodiments are provided so that this disclosure will be thorough and complete, and will fully convey the scope of the invention to those skilled in the art. In the drawings, like numbers refer to like elements.

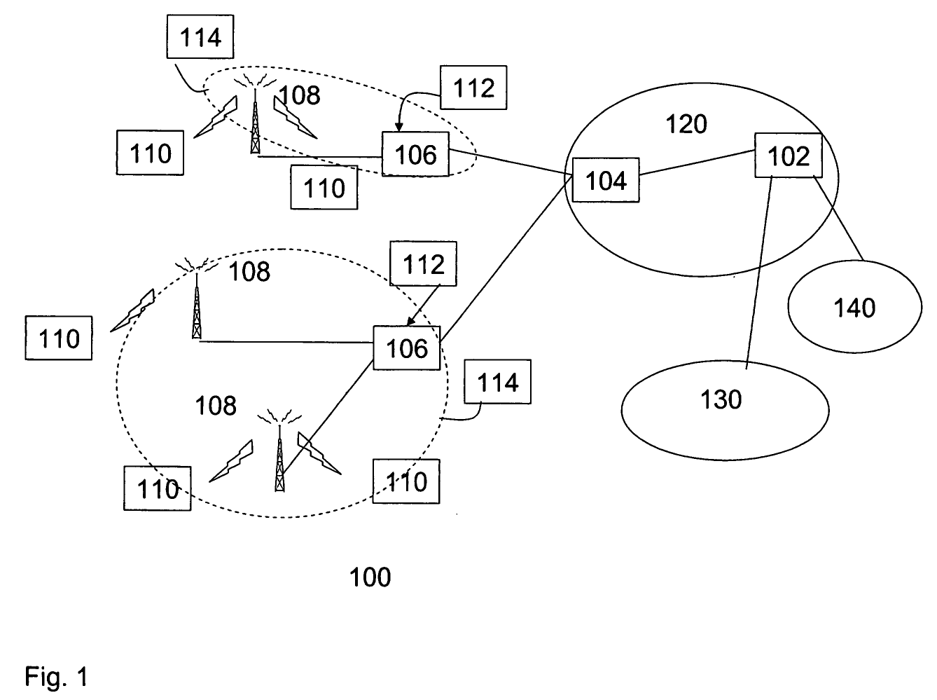

The present invention may be implemented in a third generation mobile telecommunication system as depicted in FIG. 1. FIG. 1 shows a mobile telecommunication system that comprises a first Core Network (CN) 120 comprising at least one Gateway GPRS Support Node (GGSN) 102 connected to at least one Serving GPRS Support Node (SGSN) 104. The first CN is connectable to other networks 130,140, such as the PSTN or another mobile network, by means of the GGSN. The SGSN 104 is connectable via the Iu interface to a plurality of Radio Network Subsystems (RNS) 114. Each RNS 114 comprises a Radio Network Controller (RNC) 106 and at least one Node B, also referred to as Base Station (BS), 108 connected to the RNC 106 via the Iur interface. The RNCs control their connected Node Bs 108 and the Node Bs comprise means for wireless communication over the Uu interface with a plurality of UEs also referred to as mobile terminals 110 located in the coverage of the respective Node B 108.

The basic concept of a first embodiment of the present invention is that the 20 procedure for making the S-RNC aware of MBMS UEs when the MBMS UEs are PMM-IDLE and CS connected is performed only between the SGSN and the S-RNC, i.e. over the Iu interface, instead of performing a similar procedure as the UE linking between the S-RNC and the UE as indicated in the previous existing solutions.

Thus, in the situation where a UE has joined MBMS services and is in PMM Idle state, the knowledge of which UEs that have joined MBMS service(s) is currently not known by the S-RNC. As a consequence, in the case when a PMM Idle UE moves to RRC Connected state due to a CS connection, the S-RNC would be unable to alert such a UE upon receipt of SESSION START message from the SGSN.

The solution to the problem is according to the first embodiment of the present invention to provide the information of UEs that have joined an MBMS service to the S-RNC by specifying that the S-RNC itself shall fetch this information from the SGSN.

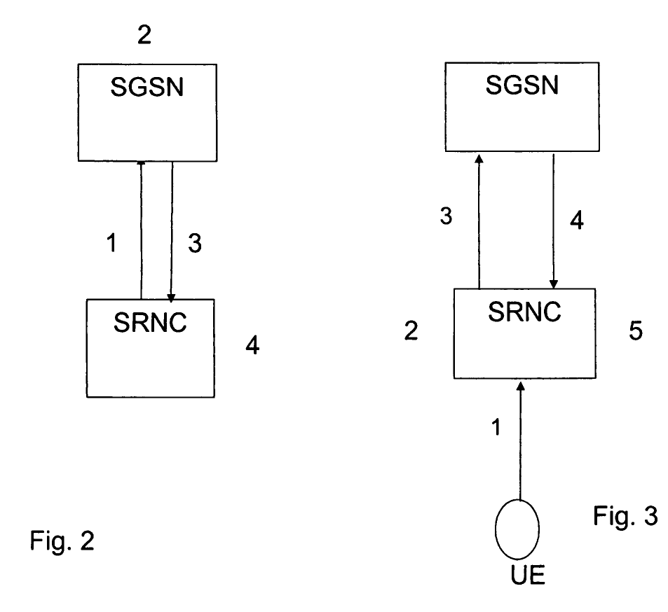

FIG. 2 illustrates schematically a procedure according to a first embodiment of the present invention. The FIG. 2 shows an RNC initiated Iu linking at CS speech set up. The UE is RRC Connected and PMM Idle. When a UE sets up a CS connection and is entering the RRC Connected and is in PMM idle state, the S-RNC sends a connectionless message denoted RANAP RRC Connection Indication message (1) to the SGSN. The message (1) indicates that the UE transits to the RRC Connected state. The SGSN then makes a check (2) with the stored MBMS context information in the SGSN and if the UE has activated MBMS for one or more sessions, the SGSN invokes a procedure denoted the Iu linking procedure (3) by sending a message denoted Iu Linking Request message to the S-RNC. If the UE has no activated MBMS, no Iu linking procedure is performed.

The S-RNC then creates the MBMS UE context (4) and keeps the UE specific MBMS context information for the UE stored as long as the UE is RRC Connected. Thus, the S-RNC is now aware of that said UE has joined the MBMS service. The UEs that have joined the MBMS are then informed that they are required to listen to the MBMS broadcast channel by means of a session start message sent from the SGSN via the RNC. The S-RNC will page according to the MBMS UE context with individual or common page depending on the UE state.

In order to clarify, the MBMS Service context is the context created in a RNC related to a specific MBMS service, such as service id, Quality of service (QoS) parameters etc. The MBMS UE context is a context for each UE that is catered for by a certain RNC and it includes the identity of the UE and the MBMS services that are applicable to this specific UE.

According to embodiments of the present invention, there are two different approaches on how to handle the UE state at reception of the message denoted RANAP Connection Indication message. In accordance with one embodiment of the present invention, the UE may either be forced to PMM connected or in accordance with a further embodiment the UE shall stay in PMM idle. Currently TS 25.346 only allows lu linking of UEs in PMM Connected mode. Forcing UE to PMM Connected requires additional Uu signalling to the UE.

Thus, this above described solution according to the first embodiment implies that the S-RNC comprises means for fetching the information about joined MBMS services, every time a PMM Idle UE establishes a RRC connection.

FIG. 3 illustrates schematically a procedure according to a second embodiment of the present invention. FIG. 3 shows a UE initiated Iu linking at CS speech set up. The UE is in the state PMM Idle and RRC connected. A UE in PMM-Idle performs a state transition from RRC idle to RRC Connected when a CS-speech or CS data connection is set up. When the UE enters RRC Connected mode and PMM idle state, the UE sends a message denoted UE joined (1) to the S-RNC in order to update the MBMS UE context in the S-RNC for one or more MBMS sessions for which the UE has joined. The UE joined message informs the S-RNC about the joined MBMS(s). By reception of the message denoted UE joined, the S-RNC checks if there already are MBMS service contexts established in the S-RNC for the concerned MBMSs. If there is no MBMS service context stored in the S-RNC for the concerned MBMSs, the S-RNC initiates a registration procedure denoted the RANAP RNC Registration procedure (3), by transmitting a message to the SGSN in order to fetch MBMS service context information from the SGSN and also to send the identity of the RNC to the SGSN. Then, the S-RNC creates the MBMS Service context and links the MBMS UE context to the MBMS Service context in the S-RNC based on a response (4) of the transmitted message from the SGSN to the S-RNC. This response may comprise a list of session identities. In the case when there already exist a MBMS Service context, the S-RNC only creates the MBMS UE context and in the case when there already exist a MBMS UE context, the S-RNC only creates the MBMS service context. It should be noted that the creation of the MBMS UE context and/or the MBMS Service context is only performed for the first MBMS UE in the cell. For the next MBMS UEs in the cell, an update of the MBMS UE context and/or the MBMS Service context is performed.

When the S-RNC receives a session start indication from the SGSN, the S-RNC is able to page the MBMS UE individually, based on the information received in the message from the UE to the S-RNC, in order to inform the UE of the session start of the MBMS. The page comprises information to the UE about which physical and logical channels that should be used for the MBMS transmission.

There is no implicit registration associated with this solution, i.e. the UE stays in PMM Idle during the CS call. The purpose of the message denoted RANAP RNC Registration message is to provide the RNC identity to the SGSN for distribution of MBMS Session Start messages. The creation of the MBMS UE context in S-RNC according to the invention is important, and the MBMS UE context is kept as long as the UE is in the RRC connected state. Due to the mobility in the radio access network, the UE may move to another RNC, during the CS call, where it needs to be paged on a dedicated channel if the MBMS session starts during the CS call. This can either be accomplished by individual paging over Iur or by Iur linking. Iur linking is a similar process as the Iu linking but via the Iur in the case when there is an Iur established for this Ue.) wherein the Start indication is received over the Iu-interface. The new UE joined indication can be implemented in RRC Connection Request as a new information field/information element or as a new RRC PDU/message. Thus, only in the case when a new RRC message is created a new message is created. Otherwise, it is possible to re-use existing messages.

The advantage with the second embodiment according to the present invention, is the explicit registration that is performed when there is no MBMS service context for that session, i.e. the registration procedure denoted the RANAP RNC Registration procedure (3). The disadvantages of the first existing solution described above is therefore avoided.

In the solutions according to the first and second embodiments of the present invention, it should be noted that the UE may in the preferred embodiments stay in PMM-Idle during the CS connection, only the S-RNC MBMS Context is updated accordingly.

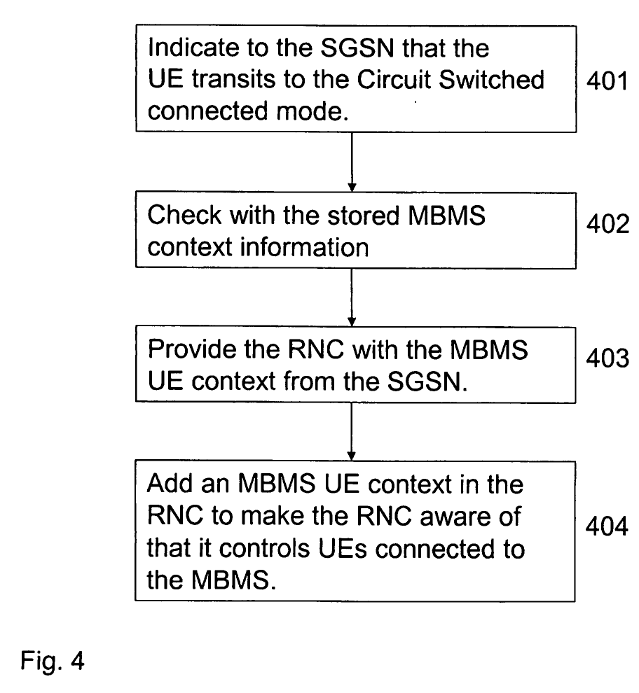

To summarize, the method performed in the RNC and the SGSN according to the first embodiment illustrated in FIG. 4 for initiating a MBMS to a UE in PMM-idle mode controlled by a RNC wherein the RNC is connected to the SGSN comprises the steps of:
401. Indicate to the SGSN that the UE transits to the Circuit Switched connected mode.
402. Check with the stored MBMS context information in the SGSN if the UE has activated the MBMS for one or more sessions.
403. Provide the RNC with the MBMS UE context from the SGSN.
404. Add an MBMS UE context in the RNC to make the RNC aware of that it controls UEs connected to the MBMS.

Thus an RNC according to the first embodiment of the present invention comprises means for indicating to the SGSN that the UE transits to the Circuit Switched connected mode, means for receiving from the SGSN an MBMS UE context, and means for adding MBMS UE context in the RNC to make the RNC aware of that it controls UEs connected to the MBMS.

Furthermore, an SGSN according to the first embodiment of the present invention comprises means for receiving an indication that the UE transits to the Circuit Switched connected mode, means for checking with the stored MBMS context information in the SGSN if the UE has activated the MBMS for one or more sessions, means for providing the RNC with the MBMS UE context in order to add MBMS UE context in the RNC to make the RNC aware of that it controls UEs connected to the MBMS.

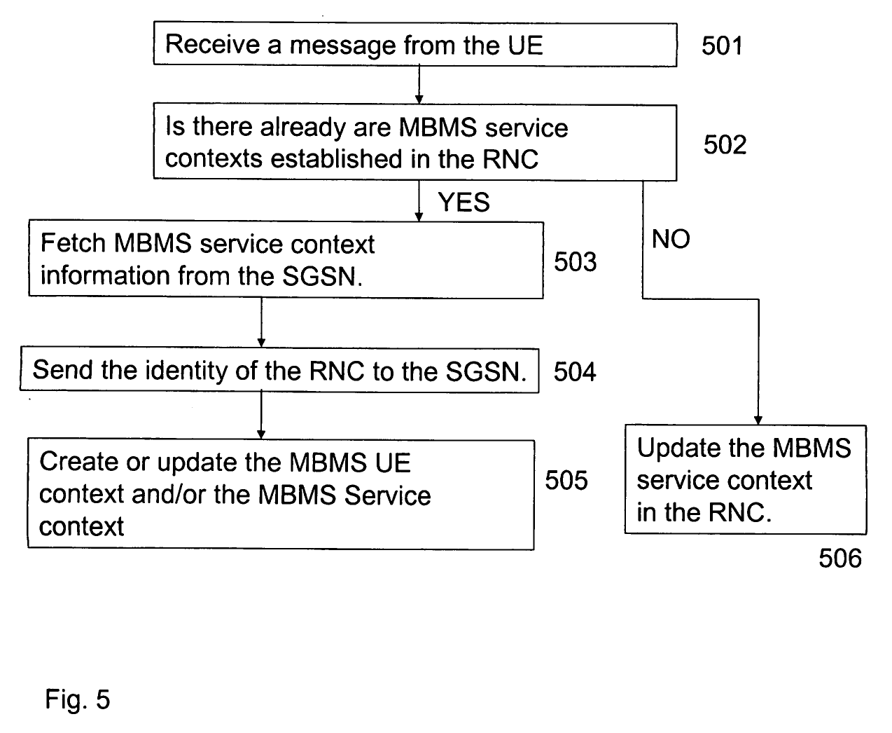

Moreover, the method in the RNC according to the second embodiment illustrated in FIG. 5 for initiating a MBMS to a UE in PMM-idle mode controlled by a RNC wherein the RNC is connected to a SGSN comprises the steps of:
501. Receive a message from the UE to the RNC in order to update the MBMS UE context in the RNC for one or more MBMS sessions for which the UE has joined.
502. Check if there already are MBMS service contexts established in the RNC for the concerned MBMSs.
If there is no MBMS service context stored in the RNC for the concerned MBMSs, the method comprises the further steps of:
   503. Fetch MBMS service context information from the SGSN.
   504. Send the identity of the RNC to the SGSN.
   505. Create or update the MBMS UE context and/or the MBMS Service context in the RNC based on the fetched information from the SGSN.
Otherwise the method comprises the further step of:
506. Update the MBMS service context in the RNC.

Thus an RNC according to the second embodiment of the present invention comprises means for receiving a message from the UE in order to update the MBMS UE context in the RNC for one or more MBMS sessions for which the UE has joined, and means for checking if there already are MBMS service contexts established in the RNC for the concerned MBMSs.

If there is no MBMS service context stored in the RNC for the concerned MBMSs, the RNC further comprises means for fetching the MBMS service context information from the SGSN, wherein said means comprises means for sending the identity of the RNC to the SGSN, creating or updating the MBMS UE context and/or the MBMS Service context in the RNC based on the fetched information from the SGSN. Otherwise the RNC comprises means for updating the MBMS service context in the RNC.

The methods above may be implemented by a computer program product. The computer program product is directly loadable into the internal memory of a computer within a Radio Network Controller and/or in a Core Network and/or in the UE in a mobile telecommunication network, and comprises the software code portions for performing the steps of said method. Furthermore, the computer program product is stored on a computer usable medium, and comprises readable program for causing a computer, within a Radio Network Controller and/or in a Core Network and/or in the UE in a mobile telecommunication system, to control an execution of the steps of said method.

It should be noted that the methods and arrangements according to the present invention also is applicable on other services such as Push to Talk, CBS (Cell Broadcast Services), Voice group Call. However, the messages may require some modifications which is obvious for a man skilled in the art.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method in a Radio Network Controller, RNC, in a mobile telecommunication system for initiating a Multimedia Broadcast Multimedia Service, MBMS, to a User Equipment, UE, in Packet Mobility Management-idle, PMM-idle, mode controlled by the RNC, wherein the RNC is connected to a Serving GPRS Support Node. SGSN, the method comprising the steps of:
indicating to the SGSN that the UE is transiting to a Circuit Switched connected mode,
receiving from the SGSN an MBMS UE context, and
adding the MBMS UE context in the RNC to make the RNC aware that the RNC controls UEs connected to the MBMS.

2. A method in a Serving GPRS Support Node, SGSN, in a mobile telecommunication system for initiating a Multimedia Broadcast Multimedia Service, MBMS, to a User Equipment, UE, in Packet Mobility Management-idle, PMM-idle, mode controlled by a Radio Network Controller, RNC, wherein the RNC is connected the SGSN, the method comprising the steps of:
receiving an indication that the UE is transiting to a Circuit Switched connected mode,
checking with the stored MBMS context information in the SGSN to determine whether the UE has activated the MBMS for one or more sessions, and
providing the RNC with the MBMS UE context in order to make the RNC aware that the RNC controls UEs connected to the MBMS.

3. The method according to claim 1, wherein the indicating step includes transmitting a message from the RNC to the SGSN.

4. The method according to claim 1, further comprising maintaining the UE in PMM-idle state at reception of the indication at the SGSN.

5. The method according to claim 1, further comprising transferring the UE to PMM-connected state at reception of the indication at the SGSN.

6. The method according to claim 2, wherein the providing step includes invoking an Iu linking procedure by sending an Iu Linking Request message to the RNC from the SGSN.

7. The method according to claim 1, further comprising keeping the added MBMS UE context in the RNC as long as the UE is RRC connected.

8-9. (canceled)

10. A method in a Radio Network Controller, RNC, in a mobile telecommunication system for initiating a Multimedia Broadcast Multimedia Service, MBMS, to a User Equipment, UE, in Packet Mobility Management-idle, PMM-idle, state and Circuit Switched connected mode, said UE being controlled by a Radio Network Controller, RNC, connected to a Serving GPRS Support Node, SGSN, the method comprising the steps of:
receiving a message from the UE in order to update the MBMS UE context in the RNC for one or more MBMS sessions for which the UE has joined,
if there is no MBMS service context information stored in the RNC for the concerned MBMSs, the method comprises the further steps of:
fetching MBMS service context information from the SGSN,
sending the identity of the RNC to the SGSN, and
creating or updating the MBMS UE context and/or the MBMS Service context in the RNC based on the fetched information from the SGSN,
if there is MBMS service context information stored in the RNC for the concerned MBMSs, the method comprises the further step of:
updating the MBMS service context in the RNC.

11. The method according to claim 10, wherein the created or updated MBMS UE context in the RNC is kept in the RNC as long as the UE is RRC connected.

12. The method according to claim 10, further comprising performing individual paging over an Iur interface or by performing Iur linking in order to page a UE that has moved to a second NC.

13. The method according to claim 10, wherein the step of receiving a message from the UE includes receiving a Radio Resource Control, RRC, Connection Request message with a new information field/information element, or receiving a new RRC PDU/message.

14. The method according to claim 10, further comprising maintaining the UE in PMM-idle state at reception of the message to the RNC.

15-16. (canceled)

17. A Radio Network Controller, RNC, in a mobile telecommunication system for initiating a Multimedia Broadcast Multimedia Service, MBMS, to a User Equipment, UE, in Packet Mobility Management-idle, PMM-idle mode controlled by the RNC, wherein the RNC is connected to a Serving GPRS Support Node, SGSN, the RNC comprising:
means for indicating to the SGSN that the UE is transiting to a Circuit Switched connected mode,
means for receiving from the SGSN an MBMS UE context, and
means for adding the MBMS UE context in the RNC to make the RNC aware that the RNC controls UEs connected to the MBMS.

18. A Serving GPRS Support Node, SGSN, in a mobile telecommunication system for initiating a Multimedia Broadcast Multimedia Service, MBMS, to a User Equipment, UE, in Packet Mobility Management-idle, PMM-idle, mode controlled by a Radio Network Controller, RNC, wherein the RNC is connected the SGSN, the SGSN comprising:
means for receiving an indication that the UE is transiting to a Circuit Switched connected mode,
means for checking with the stored MBMS context information in the SGSN to determine whether the UE has activated the MBMS for one or more sessions, and
means for providing the RNC with the MBMS UE context in order to make the RNC aware that the RNC controls UEs connected to the MBMS.

19. The RNC according to claim 17, wherein the means for indicating includes means for transmitting a message to the SGSN.

20. The SGSN according to claim 18, further comprising means for maintaining the UE in PMM-idle state at reception of the indication at the SGSN.

21. The SGSN according to claim 18, further comprising means for transferring the UE to PMM-connected state at reception of the indication at the SGSN.

22. The SGSN according to claim 18, wherein the means for providing includes means for invoking an Iu linking procedure by sending an Iu Linking Request message to the RNC from the SGSN.

23. The RNC according to claim 17. wherein the added MBMS UE context in the RNC is kept in the RNC as long as the UE is RRC connected.

24. A Radio Network Controller, RNC, in a mobile telecommunication system for initiating a Multimedia Broadcast Multimedia Service, MBMS, to a User Equipment, UE, in Packet Mobility Management-idle, PMM-idle, state and Circuit Switched connected mode, said UE being controlled by the RNC, wherein the RNC is connected to a Serving GPRS Support Node, SGSN, the RNC comprising:
means for receiving a message from the UE in order to update the MBMS UE context in the RNC for one or more MBMS sessions for which the UE has joined, means for checking if there already are MBMS service contexts established in the RNC for the concerned MBMSs,
if there is no MBMS service context information stored in the RNC for the concerned MBMSs, the RNC further comprises:
means for fetching MBMS service context information from the SGSN,
means for sending the identity of the RNC to the SGSN, and
means for creating or updating the MBMS UE context and/or the MBMS Service context in the RNC based on the fetched information from the SGSN,
if there is MBMS service context information stored in the RNC for the concerned MBMSs, the RNC comprises the means for updating the MBMS service context in the RNC.

25. The RNC according to claim 24, wherein the RNC comprises means for keeping the created or updated MBMS UE context in the RNC as long as the UE is RRC connected.

26. The RNC according to claim 24, further comprising means for performing individual paging over an Iur interface or means for performing Iur linking in order to page a UE that has moved to a second RNC.

27. The RNC according to claim 24, wherein the message received from the UE is received in a Radio Resource Control, RRC, Connection Request message as a new information field/information element, or is received as a new RRC PDU/message.

28. The RNC according to claim 24, wherein the RNC further comprises means for maintaining the UE in PMM-idle state at reception of the message to the RNC.
